(19) United States
(12) Patent Application Publication
(10) Pub. No.: US 2011/0259018 A1
(43) Pub. Date: Oct. 27, 2011

(54) Thermoelectric module and method for manufacturing the same

(75) Inventors: Sung Ho Lee, Seongnam-si (KR); Yong Suk Kim, Yongin-si (KR); Tae Kon Koo, Seoul (KR); Young Soo Oh, Seongnam-si (KR); Sung Kwon Wi, Seoul (KR)

(73) Assignee: SAMSUNG ELECTRO-MECHANICS CO., LTD., Suwon (KR)

(21) Appl. No.: 12/805,142

(22) Filed: Jul. 14, 2010

(30) Foreign Application Priority Data
Apr. 27, 2010 (KR) 10-2010-0038972

(51) Int. Cl. F25B 21/02; H01R 43/00

(52) U.S. Cl. 62/3.2; 29/825

(57) ABSTRACT

Disclosed herein are a thermoelectric module including a first substrate and a second substrate that are opposite to each other and spaced from each other; first and second electrodes that are disposed on the inner side surfaces of the first and second substrates, respectively; and a thermoelectric element that is interposed between the first and second electrodes and is electrically bonded to the first and second electrodes, wherein at least any one of the first and second substrates has an insulating layer disposed on one surface and a fluid flowing line for moving a fluid transferring heat therein, and a method for manufacturing the same.

### CROSS REFERENCE TO RELATED APPLICATION

This application claims the benefit of Korean Patent Application No. 10-2010-0038972, filed on Apr. 27, 2010, entitled “Thermoelectric Module and Method for Manufacturing the Same”, which is hereby incorporated by reference in its entirety into this application.

### BACKGROUND OF THE INVENTION

1. Technical Field

The present invention relates to a thermoelectric module, and more particularly, to a thermoelectric module that includes at least one substrate having a fluid flowing line for moving a fluid transferring heat therein and a method for manufacturing the same.

2. Description of the Related Art

A sudden increase in use of fossil energy causes global warming and exhaustion of energy, such that more research on a thermoelectric module capable of efficiently using energy has been recently conducted.

Herein, the thermoelectric module may be used as a power generator using a seebeck effect that generates electromotive force when both ends of the thermoelectric element have difference in temperature or a cooler using a peltier effect that generates heat at one end of the thermoelectric element and absorbs heat at the other end thereof when direct current is applied to the thermoelectric element.

The thermoelectric module may include upper and lower electrodes, and a thermoelectric element interposed between the upper and lower electrodes. Herein, a substrate is disposed on each upper surface of the upper and lower electrodes in order to support the thermoelectric module. At this time, the substrate mainly uses an alumina substrate having excellent electrical insulation.

However, the alumina substrate has low thermal conductivity, such that the thermoelectric performance and the heat transfer performance of the thermoelectric module are degraded.

### SUMMARY OF THE INVENTION

The present invention proposes to solve the problems that may be generated from a thermoelectric module. More specifically, an object of the present invention is to provide a thermoelectric module that includes at least one substrate having a fluid flowing line for moving a fluid transferring heat therein to increase a heat radiation effect through the substrate, thereby making it possible to improve heat transfer efficiency, and a method for manufacturing the same.

An object of the present invention is to provide a thermoelectric module. The thermoelectric module includes: a first substrate and a second substrate that are opposite to each other and spaced from each other; first and second electrodes that are disposed on the inner side surfaces of the first and second substrates, respectively; and a thermoelectric element that is interposed between the first and second electrodes and is electrically bonded to the first and second electrodes, wherein at least any one of the first and second substrates has an insulating layer disposed on one surface and a fluid flowing line for moving a fluid transferring heat therein.

Herein, the insulating layer may be made of any one of SiO₂, Al₂O₃, TiO₂, ZnO, NiO and Y₂O₃.

Further, the insulating layer may have a thickness in the range of 0.2 μm to 10 μm.

The thermoelectric module may further include thermal grease that is interposed between at least any one of the first substrate and the first electrode, the second substrate and the second electrode, the thermoelectric element and the first electrode, and the thermoelectric element and the second electrode.

Further, the thermoelectric element may be bonded to the first and second electrodes by solder.

Further, the moving direction of the fluid flowing line may correspond to the longitudinal direction of the first electrode or the longitudinal direction of the second electrode, and the fluid flowing line may pass through the first electrode or the second electrode.

Another object of the present invention is to provide a method for manufacturing a thermoelectric module. The method for manufacturing a thermoelectric module includes: forming a first electrode on a first substrate; forming a first solder layer on the first electrode; disposing a thermoelectric element on the first solder layer; providing a second substrate over the first substrate so that the thermoelectric element and a second solder layer correspond to a second electrode; and bonding the first and second electrodes to the thermoelectric element by the first and second solder layers by performing a reflow process on the first and second substrates, wherein at least any one of the first and second substrates has a fluid flossing line for moving a fluid transferring heat therein, and an insulating layer is formed on the upper surface of the substrate having the fluid flowing line.

Herein, the insulating layer may be made of any one of SiO₂, Al₂O₃, TiO₂, ZnO, NiO and Y₂O₃ on the substrate having the fluid flowing line.

Further, the insulating layer may have a thickness in the range of 0.2 μm to 10 μm.

Further, thermal grease may further be interposed between at least any one of the first substrate and the first electrode, the second substrate and the second electrode, the thermoelectric element and the first electrode, and the thermoelectric element and the second electrode.

### BRIEF DESCRIPTION OF THE DRAWINGS

FIG. 1 is a perspective view of a thermoelectric module according to a first embodiment of the present invention;

FIG. 2 is a cross-sectional view showing a portion of the thermoelectric module of FIG. 1; and

FIGS. 3 to 7 are cross-sectional views explaining a method for manufacturing a thermoelectric module according to a second embodiment of the present invention.

### DESCRIPTION OF THE PREFERRED EMBODIMENTS

Hereinafter, exemplary embodiments of the present invention will be described in detail with reference to the drawings of a thermoelectric module. The exemplary embodiments of the present invention to be described below are provided by way of example so that the idea of the present invention can be sufficiently transferred to those skilled in the art to which the present invention pertains.

Therefore, the present invention may be modified in many different forms and it should not be limited to the embodiments set forth herein. In the drawings, the size and the thickness of the device may be exaggerated for convenience. Like reference numerals designate like components throughout the specification.

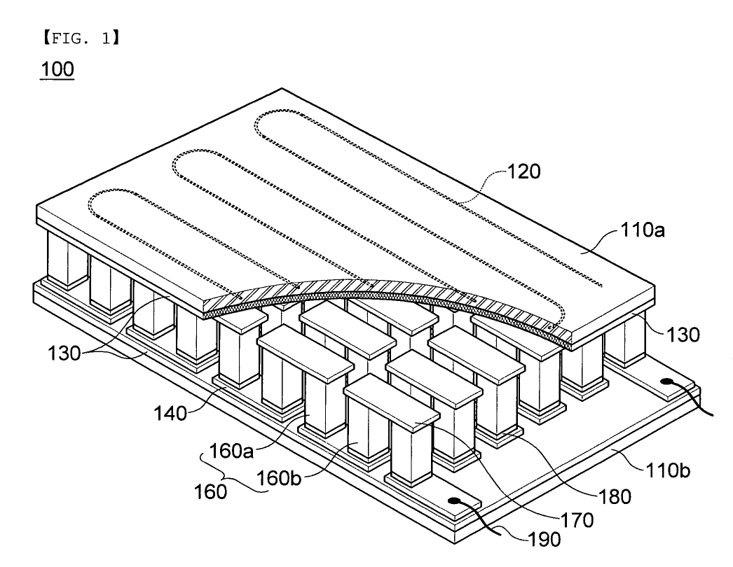

FIG. 1 is a perspective view of a thermoelectric module according to a first embodiment of the present invention.

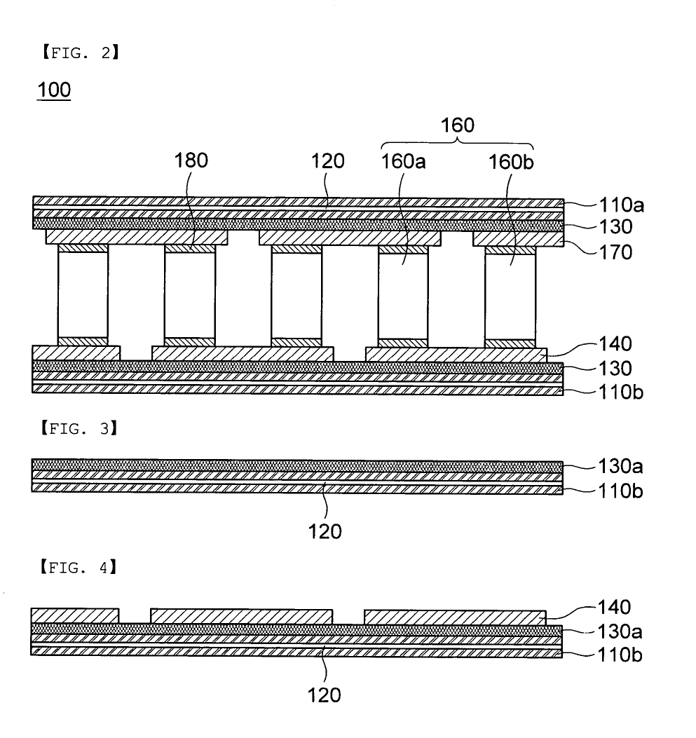

FIG. 2 is a cross-sectional view showing a portion of the thermoelectric module of FIG. 1.

Referring to FIGS. 1 and 2, a thermoelectric module 100 according to a first embodiment of the present invention may include first and second substrates 110a and 110b that are opposite to and spaced from each other, first and second electrodes 140 and 170 and a thermoelectric element 160 that are interposed between the first and second substrates 110a and 110b.

The first and second substrates 110a and 110b may serve to support the thermoelectric element 160 and the first and second electrodes 140 and 170. Further, when a plurality of thermoelectric elements 160 are provided, the first and second substrates 110a and 110b may serve to connect the plurality of thermoelectric elements 160.

In addition, the first substrate 110a and the second substrate 110b may be joined to an external apparatus to absorb heat from the outside or radiate heat to the outside through the heat exchange of the thermoelectric element 160. That is, the first substrate 110a and the second substrate 110b may serve to perform a heat transfer between the external apparatus and the thermoelectric element 160. Therefore, the efficiency of the thermoelectric module may be affected by the thermal conductivity of the first and second substrates 110a and 110b.

To this end, the first and second substrates 110a and 110b may be made of a metal having excellent thermal conductivity. For example, the first and second substrates 110a and 110b may be made of aluminum, copper, or the like. Therefore, the first and second substrates 110a and 110b have excellent thermal conductivity, thereby making it possible to improve heat transfer efficiency.

In addition, the first and second substrates 110a and 110b have a fluid flowing line 120 for moving a fluid transferring heat, thereby making it possible to more improve the thermal conductivity. Therefore, the first and second substrates 110a and 110b can radiate heat or absorb heat from or to the thermoelectric element 160 at a rapid speed, thereby making it possible to more improve the heat transfer efficiency. At this time, the fluid may be made of a material that can transfer heat through a phase change between gas and liquid. Herein, the fluid may be a liquid having a low boiling point, for example, acetone, alcohol, or the like.

When seen in a cross-section, the fluid flowing line 120 may have a circular penetration shape so as to have a space for filling the fluid, but the embodiment of the present invention is not limited thereto.

In addition, the moving direction of the fluid flowing line 120 may correspond to the longitudinal direction of the first and second electrodes 140 and 170 and at this time, the fluid flowing line 120 may be disposed to pass through the first and second electrodes 140 and 170. Therefore, the fluid flowing line 120 can increase a contact area with the first and second electrodes 140 and 170, thereby making it possible to more improve the heat transfer efficiency.

In the embodiment of the present invention, although the fluid flowing line 120 is described to be provided on the first substrate 110a and the second substrate 110b, respectively, it is not limited thereto. The fluid flowing line 120 may also be provided on any one of the first and second substrates 110a and 110b.

In addition, the first and second substrates 110a and 110b may have electrical insulation by disposing an insulating layer 130 on the inner side surfaces of the first substrate 110a and the second substrate 110b. At this time, the insulating layer 130 may be made of a material having durability capable of enduring a process of forming the thermoelectric module 100. For example, the insulating layer 130 may be made of any one of SiO₂, Al₂O₃, TiO₂, ZnO, NiO and Y₂O₃.

Herein, the insulating layer 130 may have a thickness in the range of 0.2 μm to 10 μm. If the insulating layer 130 has a thickness below 0.2 μm, it is difficult to ensure insulation. In contrast, if the insulating layer 130 has a thickness exceeding 10 μm, it may degrade the thermal conductivity between the first substrate 110a or the second substrate 110b and the thermoelectric element 160.

In addition, the insulating layer 130 can not only ensure insulation between the first substrate 110a and the second substrate 110b but also fill up voids generated by a process of forming the fluid flowing line 120 on the first substrate 110a and the second substrate 110b. Therefore, the insulating layer 130 can prevent degradation of the heat transfer between the first substrate 110a and the first electrode 140 and between the second substrate 110b and the second electrode 170 due to the voids.

Meanwhile, the thermoelectric element 160 may include a P type semiconductor 160a and an N type semiconductor 160b. At this time, the P type semiconductor 160a and the N type semiconductor 160b may be alternately arranged on the same plane.

At this time, the first and second electrodes 140 and 170 may be disposed to be opposite to each other, having the thermoelectric element 160 therebetween. At this time, a pair of P type semiconductor 160a and N type semiconductor 160b may be electrically connected by the first electrode 140 disposed at the lower surfaces thereof, and another pair of P type semiconductor 160a and N type semiconductor 160b adjacent thereto may be electrically connected by the second electrode 170 disposed at the upper surfaces thereof.

The first electrode 140 and the second electrode 170 may be bonded to the thermoelectric element 160 by solder 180. Herein, the solder 180 may include Sn such as PbSn, CuAgSn, or the like.

In addition, the first and second electrodes 140 and 170 may be connected to an external power supply unit by a wire 190 to supply or receive power to and from the external power supply unit. That is, when the thermoelectric module 100 functions as a power generator, the first and second electrodes 140 and 170 may supply power to the external power supply unit and when the thermoelectric module 100 functions as a cooler, the first and second electrodes 140 and 170 may receive power from the external power supply unit.

Further, although not shown in the figure, thermal grease may be formed on a boundary surface between respective components. For example, the thermal grease may be interposed between at least one of the first substrate 110a and the first electrode 140, the second substrate 110b and the second electrode 170, the thermoelectric element 160 and the first electrode 140, and the thermoelectric element 160 and the second electrode 170. Herein, the thermal conductive copper may serve to fill the voids formed on each boundary surface and prevent thermal conductivity from being degrade due to the voids.

Therefore, as shown in the embodiment of the present invention, the fluid flowing line is provided in at least one of the first and second substrates, such that thermal conductivity between the outside and the thermoelectric element can be improved, thereby making it possible to more improve the efficiency of the thermoelectric module.

Hereinafter, a method for manufacturing a thermoelectric module according to an embodiment of the present invention will be described in detail with reference to FIGS. 3 to 7.

FIGS. 3 to 7 are cross-sectional views explaining a method for manufacturing a thermoelectric module according to a second embodiment of the present invention.

Referring to FIG. 3, a first substrate 110a is first provided so as to manufacture a thermoelectric module. Herein, a fluid flowing line 120 may be provided inside the first substrate 110a so as to move a fluid. Herein, the fluid may be a liquid capable of transferring heat through a phase change by heat, for example, alcohol and acetone. At this time, the fluid flowing line 120 is sealed, such that it may be blocked form the outside.

The fluid flowing line 120 may be formed on the first substrate 110a by bonding upper and lower plates having groove lines opposite to each other. Thereafter, a grinding process and a cleaning process may further be performed on the first substrate 110a so as to flat support thermoelectric elements to be described below.

The first substrate 110a may be made of a metal material having excellent thermal conductivity. Herein, the first substrate 110a is made of a conductive material, such that a first insulating layer 130a is formed on the first substrate.

The first insulating layer 130 may be made of any one of Sio2, Al2O3, TiO2, ZnO, NiO and Y₂O₃. Herein, the method for forming the first insulating layer 130a may be a printing method, an atom layer deposition method, a sputtering method, an E-beam method, a chemical vapor deposition (CVD) method, or the like, by way of example, but the embodiment of the present invention is not limited thereto. Further, the first insulating layer 130a may have a thickness in the range of 0.2 μm to 10 μm in consideration of ensurance of insulation and effects of thermal conductivity.

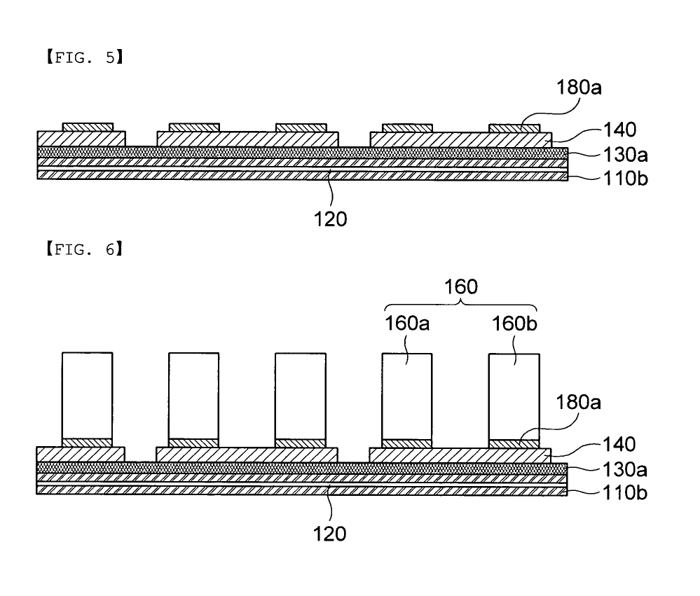

Referring to FIG. 4, after the first insulating layer 130a is formed on the first substrate 110a, a first electrode 140 is formed on the first insulating layer 130a. Herein, the first electrode 140 may be formed by patterning a conductive layer after forming the conductive layer by depositing a conductive material. However, the embodiment of the present invention does not limit the method for forming the first electrode 140, but the first electrode 140 may also be formed by, for example, a plating process, a printing process, or the like.

Referring to FIG. 5, after the first electrode 140 is formed, a first solder layer 180a is formed on the first electrode 140. The first solder layer 180a may be formed by printing a conductive paste including Sn, such as PbSn, CuAgSn, or the like.

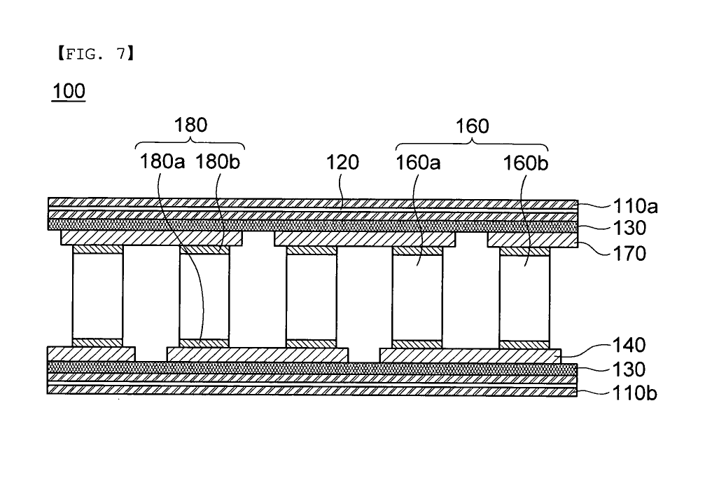

Referring to FIG. 6, after the first solder layer 180a is formed, a thermoelectric element 160 is disposed on the first solder layer 180a. Herein, the thermoelectric element 160 may include a P type semiconductor 160a and an N type semiconductor 160b, wherein the P type semiconductor 160a and the N type semiconductor 160b may be alternately disposed.

Meanwhile, referring to FIG. 7, a second substrate 110b including a fluid flowing line 120 is provided. A second insulating layer 130b, a second electrode 170, and a second solder layer 180b are formed on the inner side surface of the second substrate 110b in sequence. Herein, the second insulating layer 130b, the second electrode 170, and the second solder layer 180b may be formed by the material and the forming method of the first insulating layer 130a, the first electrode 140, and the first solder layer as described above.

Thereafter, after the second substrate 110b is disposed on the first substrate 110a so that the thermoelectric element 160 contacts the second electrode 170, the first and second electrodes 140 and 170 are bonded to the thermoelectric element 160 by a reflow process, thereby making it possible to manufacture the thermoelectric module.

In addition, although not shown in the figure, the thermal grease may be formed on the boundary surface between respective components. For example, the thermal grease may be formed between at least any one of the first substrate 110a and the first electrode 140, the second substrate 110b and the second electrode 170, the thermoelectric element 160 and the first electrode 140, and the thermoelectric element 160 and the second electrode 170.

Therefore, as shown in the embodiment of the present invention, the thermoelectric module is manufactured using the substrate including the fluid flowing line, thereby making it possible to manufacture the thermoelectric module that can improve heat transfer efficiency.

According to the present invention, the thermoelectric module uses the substrate having the fluid flowing line therein, such that it is possible to radiate heat or absorb heat from or to the thermoelectric element at a rapid speed, thereby making it possible to improve heat transfer efficiency.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the spirit and scope of the present invention is not limited to the exemplary embodiments and should be defined by the appended claims and the equivalents thereoto.

What is claimed is:

1. A thermoelectric module, comprising:
a first substrate and a second substrate that are opposite to each other and spaced from each other;
first and second electrodes that are disposed on the inner side surfaces of the first and second substrates, respectively; and
a thermoelectric element that is interposed between the first and second electrodes and is electrically bonded to the first and second electrodes,
wherein at least any one of the first and second substrates has an insulating layer disposed on one surface and a fluid flowing line for moving a fluid transferring heat therein.

2. The thermoelectric module according to claim 1, wherein the insulating layer is made of any one of SiO₂, Al₂O₃, TiO₂, ZnO, NiO and Y₂O₃.

3. The thermoelectric module according to claim 1, wherein the insulating layer has a thickness in the range of 0.2 μm to 10 μm.

4. The thermoelectric module according to claim 1, further comprising:
thermal grease that is interposed between at least any one of the first substrate and the first electrode, the second substrate and the second electrode, the thermoelectric element and the first electrode, and the thermoelectric element and the second electrode.

5. The thermoelectric module according to claim 1, wherein the thermoelectric element is bonded to the first and second electrodes by solder.

6. The thermoelectric module according to claim 1, wherein the moving direction of the fluid flowing line corresponds to the longitudinal direction of the first electrode or the longitudinal direction of the second electrode, and the fluid flowing line 120 passes through the first electrode or the second electrode.

7. A method for manufacturing a thermoelectric module, comprising:
forming a first electrode on a first substrate;
forming a first solder layer on the first electrode;
disposing a thermoelectric element on the first solder layer;
providing a second substrate over the first substrate so that the thermoelectric element and a second solder layer correspond to a second electrode; and
bonding the first and second electrodes to the thermoelectric element by the first and second solder layers by performing a reflow process on the first and second substrates,
wherein at least any one of the first and second substrates has a fluid flowing line for moving a fluid transferring heat therein, and an insulating layer is formed on the upper surface of the substrate having the fluid flowing line.

8. The method for manufacturing a thermoelectric module according to claim 7, wherein the insulating layer is made of any one of SiO₂, Al₂O₃, TiO₂, ZnO, NiO and Y₂O₃ on the substrate having the fluid flowing line.

9. The method for manufacturing a thermoelectric module according to claim 7, wherein the insulating layer has a thickness in the range of 0.2 μm to 10 μm.

10. The method for manufacturing a thermoelectric module according to claim 7, wherein thermal grease is further interposed between at least any one of the first substrate and the first electrode, the second substrate and the second electrode, the thermoelectric element and the first electrode, and the thermoelectric element and the second electrode.
